(19) United States
(12) Patent Application Publication
(10) Pub. No.: US 2002/0073003 A1
(43) Pub. Date: Jun. 13, 2002

(54) Disbursement tracking system

(76) Inventor: Mark Levine, Pinedale (CA)

Correspondence Address: Ladas & Parry, 224 South Michigan Avenue, Chicago, IL, 60604, US

(21) Appl. No.: 09/736,899

(22) Filed: Dec. 13, 2000

(51) Int. Cl. G06F 17/60; G06G 7/00

(52) U.S. Cl. 705/30; 705/400; 709/224; 709/226

(57) ABSTRACT

A disbursement tracking system for validating and controlling the usage of output devices on which costs are incurred. The disbursement tracking system includes a processing unit for receiving input signals conveying data associated with a document a user desires to generate on an output device. The processing unit is operative to extract document print information and device information from the input signals and to generate an output signal on a basis of the document print information. On a basis of the device information, the processing unit determines the status of the output device. If the status of the output device does not require cost allocation data, the output signal is transmitted to the output device without modification. If the status of the output device requires cost allocation data, the processing unit is operative to retrieve from the user, and attempt to validate, the cost allocation data. If validated, the cost allocation data is inserted into the output signal and the output signal including the cost allocation data is transmitted to the output device.

### FIELD OF THE INVENTION

The present invention relates to a disbursement tracking system for validating and controlling the usage of digital devices on which costs are incurred, such as a digital printer/copier device. In particular, the disbursement tracking system is characterized by the ability to validate the transmission of document print information from a document creation device to a digital output device.

### BACKGROUND OF THE INVENTION

In recent years, the laser printer and digital copier technologies have merged such that, today, most digital copiers are also network printers. In addition, most corporations, professional firms and institutions are connected to local and wide area networks and have means to send documents around the globe. As a result of these technological breakthroughs, end users have been given the ability to quickly generate massive amounts of printed documents. Thus, there has been a growing demand from corporations, professional firms and institutions to have a means to monitor and control the potentially massive expenses these new copier/printers can generate.

Electronic disbursement tracking is a solution adopted by many professional firms, whereby an electronic controller is interfaced with every copier/printer and print control software is installed either on each user's desktop or on print servers. The electronic controllers are responsible for monitoring and/or enabling access to use the copier/printer for the purpose of walk-up copying, and the print control software performs the same tasks for network printing. A typical electronic controller has its own keyboard and screen for entering data and displaying information respectively. The print control software uses the keyboard and display resources of the client workstation and print server as needed. The purpose of such devices is to limit access to the copier/printer until a user has entered a valid identification code and assigned a valid file number so that expenses incurred can be properly attributed back to a particular user and client.

Unfortunately, there has been little success adapting the current generation of electronic disbursement tracking devices to corporate and institutional markets. The primary reason for this fact is that a typical corporation or institution does not bill clients for disbursement expenses associated with the purchase, installation and support of these devices, and thus can not justify the expense of electronic disbursement tracking devices. This is contrary to the situation of most professional firms, which invoice their clients for all disbursement expenses incurred by the electronic disbursement tracking devices, such that all costs are recoverable and thus justifiable.

In recognition of the need for affordable digital copier/printer management systems in the corporate and institutional markets, digital copier/printer manufacturers such as The Document Company Xerox have developed standards so that vendors of disbursement control devices can adapt their solutions for these markets. The essence of these standards is for all walk-up and network functionality to be integrated within the digital copier/printer itself. Thus, there is no additional hardware required to add disbursement control to such systems.

The obvious benefit of these new implementation standards is that disbursement tracking can be made affordable for the corporate and institutional markets. However, these standards only apply to devices on which they are implemented. In a homogeneous new installation of digital copier/printer devices, the solution works very well. Unfortunately, most installations are heterogeneous, combining many types of devices and many generations of technologies. Further, the validation of the cost allocation variables is managed by the digital copier/printer. It is possible for a very large document to be sent from a workstation to the copier/printer device, only to have it rejected due to an invalid entry. This corresponds to an important inefficiency in both bandwidth usage and job completion time.

The background information provided above clearly indicates that there exists a need in the industry to provide an improved disbursement tracking system for validating and controlling the usage of digital devices on which costs are incurred, such as a digital printer/copier device.

### SUMMARY OF THE INVENTION

In one aspect, the invention provides a disbursement tracking system having an input for receiving input signals conveying data associated with a document a user desires to generate on an output device. In a specific, non-limiting example of implementation, the input signals convey document print information as well as device information, the latter identifying the output device to which the document print information is to be transmitted. The disbursement tracking system includes a processing unit that processes the input signals, extracting therefrom the document print information and the device information, and generates an output signal for transmission to the output device. On a basis of the device information, the processing unit determines the status of the output device. If the output device requires cost allocation data, such as a user identification number and a file number, the processing unit retrieves from the user values for the cost allocation data, attempts to validate the same and, if validated, inserts the cost allocation data into the output signal. The disbursement tracking system further includes an output for releasing the output signal to the output device, the latter being responsive to the output signal for generating the document in its original form.

The advantages of this disbursement tracking system are twofold. First, the disbursement tracking system is external to the output device, such that it can be shared amongst many different and remote output devices. Second, the disbursement tracking system validates all cost allocation variables prior to transmission of the document print information over a network to the output device, reducing both the job completion time and the bandwidth usage in the case of invalid entries such that there is less waste of network resources.

In a specific non-limiting example of implementation, the output device is a digital printer/copier device. The disbursement tracking system is software implemented and resides on a computing device, such as a workstation, where resides the application with which the document was originally created. In particular, the processing unit contains a redirector unit that is responsible for intercepting document print information issued by the application and the components of the operating system responsible for carrying out the printing operation. The redirector unit receives at one input various print signals from both the application and the operating system, and directs them to either a document analysis unit or a device analysis unit. In particular, the redirector directs the document print information to the document analysis unit and the device information to the device analysis unit. In a specific example, the device information includes an identifier of the output device on which the document is to be generated.

The document analysis unit spools the data contained in the document print information to create a print job file. The document analysis unit builds and maintains the print job file until one of two conditions is met. The first case occurs when the document print information contains a command to cancel the print job, in which case the print job file is discarded. In the second case, where a command indicates that all document print information has been transmitted, the document analysis unit sends a signal to the device analysis unit containing a request for cost allocation data. In this specific example of implementation, the device analysis unit may respond to such a request from the document analysis unit with one of three response signals: a first control signal including valid device specific cost allocation data, a second control signal indicating that the print job file is to be discarded, a third control signal indicating that no cost allocation data is required or a fourth control signal indicating that cost allocation data is required but not yet available.

In the case where no cost allocation data is required, the print job file is released unmodified from the document analysis unit to the output device. In the case where cost allocation data is available and included in the response signal, the document analysis unit will modify the print job file by inserting the cost allocation data into the print job file according to a predefined format. The modified print job file is then released to the output device. In the case where cost allocation data is required but not yet available, the document analysis unit will wait for receipt of the first control signal from the device analysis unit indicating that the data has been validated. When the first control signal is received, the document analysis unit follows the procedure for inserting the cost allocation data into the print job file and releasing the print job file to the output device.

The device analysis unit includes a data structure storing status information on a plurality of different output devices. Upon receiving a device identifier from the redirector unit, the device analysis unit consults the data structure on a basis of this device identifier in order to determine the status of the output device. The status information stored in the data structure includes an indication as to whether or not the output device requires cost allocation data. If the output device does require device specific cost allocation data, the device analysis unit is responsible for collecting and validating the cost allocation data from the user.

The device analysis unit includes an interface unit for retrieving from the user cost allocation data, such as the name or identifier of the client to whom the charge will be attributed, and/or details about the individual that has incurred the charge. In a specific, non-limiting example, the cost allocation data is a combination of several data elements, namely:

1. User identification code;

2. User password

3. Name of client

4. Client matter

The user enters the cost allocation data through the user interface. Under this specific example, the device analysis unit creates a data capture dialog box or screen on the display of the workstation where the user is required to key in the cost allocation data. Once the data entry process is completed, the device analysis unit will attempt to validate the cost allocation data. The validation process involves checking the data to determine if it is valid or legitimate. In the affirmative, the device analysis unit will generate the first control signal, including the validated cost allocation data, and will send this signal to the document analysis unit. If the cost allocation data entered by the user is invalid, the device analysis unit will generate the second control signal and will send this signal to the document analysis unit, where the print job file will be discarded.

In another aspect, the invention provides a computer readable storage medium containing a program element for execution by a computing apparatus to implement a disbursement tracking system.

In yet another aspect, the invention provides a data processing device having an input for receiving input signals containing data associated with a document a user desires to generate on an output device. The data processing device includes a redirector unit for extracting from the input signals document print information and device information, a document analysis unit for generating an output signal on a basis of the document print information and a device analysis unit for determining the status of the output device on a basis of the device information. If the status of the output device requires cost allocation data, the device analysis unit retrieves from the user the cost allocation data, attempts to validate the cost allocation data and, if validated, generates a control signal including the cost allocation data. The document analysis unit is responsive to this control signal for inserting the validated cost allocation data into the output signal and releasing the output signal, including the cost allocation date, to the output device.

The invention further provides a method for validating and controlling the transmission of document print information from a document creation device to an output device on which costs are incurred.

### BRIEF DESCRIPTION OF THE DRAWINGS

These and other features of the present invention will become apparent from the following detailed description considered in connection with the accompanying drawings. It is to be understood, however, that the drawings are provided for purposes of illustration only and not as a definition of the boundaries of the invention, for which reference should be made to the appending claims.

FIG. 1 is a block diagram of a typical network arrangement using a printer/copier device;

FIG. 2 is a reproduction of a typical Windows95 (trademark) print dialog box;

FIG. 3 is a functional block diagram of a disbursement tracking system in accordance with an embodiment of the present invention;

FIG. 4 is a functional block diagram of a document analysis unit;

FIG. 5 is a functional block diagram of a device analysis unit;

FIG. 6 is a diagram that illustrates the events occurring when a 32 bit Windows95 application is printing a job with the disbursement tracking system resident;

FIG. 7 is a block diagram of a computing device forming a suitable platform for the software implementation of the disbursement tracking system in accordance with an embodiment of the invention.

### DETAILED DESCRIPTION

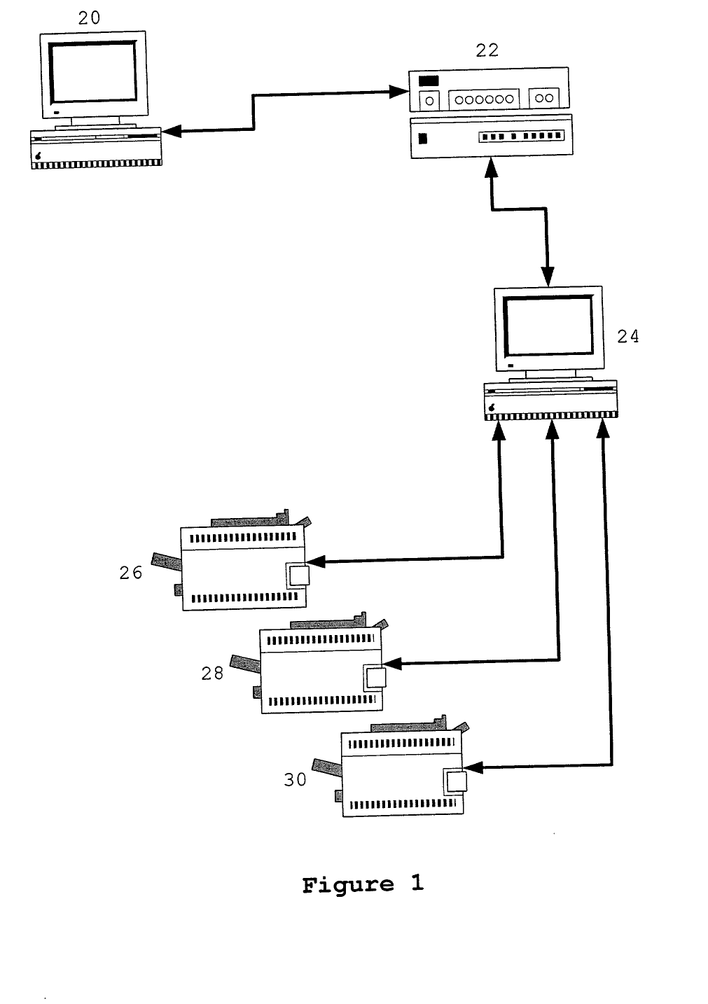

FIG. 1 illustrates a typical arrangement of a network with printing facilities. A workstation 20 is connected to a hub and bridge combination 22 that in turn is connected to three output devices through a print server 24, specifically digital printer/copier devices 26, 28, 30. Applications on the workstation 20, such as a word processor and drawing software, can print documents on, for example, the printer/copier device 28 by sending messages to the printer/copier device 28. For the purpose of this example, assume that the operating system at the workstation 20 is Windows95 (trademark).

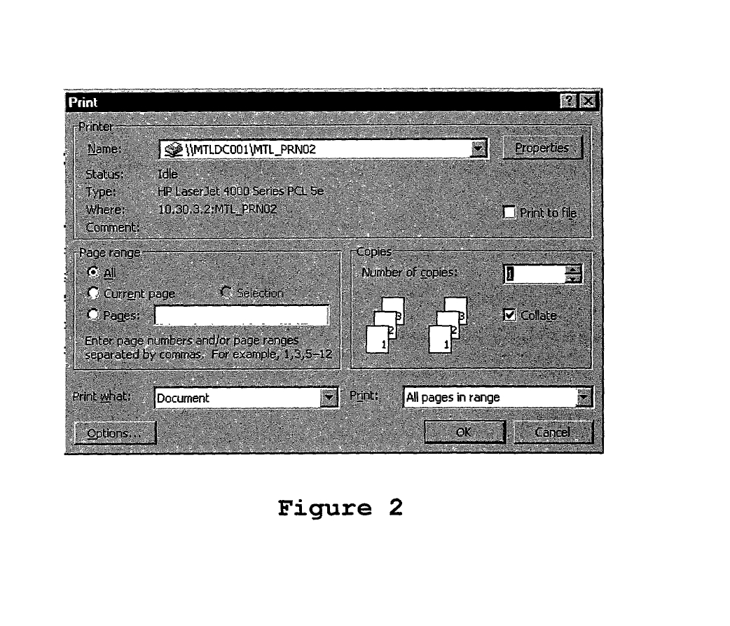

When the user at the workstation 20 desires to print on printer/copier device 28, he or she invokes the print command under the application that has generated the document to be printed. Assume for the sake of this example that the document contains only typed text. The print command causes the appearance on the screen of the dialog box illustrated in FIG. 2. The user is required to enter some data and then to click the “Ok” button with a pointing device in order to complete the print function. By selecting the name for printer/copier device 28 from the drop-down list provided at the top of the dialog box, the user opts to generate the document on printer/copier device 28.

The signals exchanged between the workstation 20 and the print server 24 convey document print information and device information. The document print information encompasses two types of data, namely print data and printer commands. The print data is the contents of the document that is to be printed on the printer/copier device 28, while the printer commands specify how the print data is to be handled by the printer/copier device 28. The device information conveys identification information relative to the printer/copier device on which the document print information is to be generated, such as an identifier of printer/copier device 28.

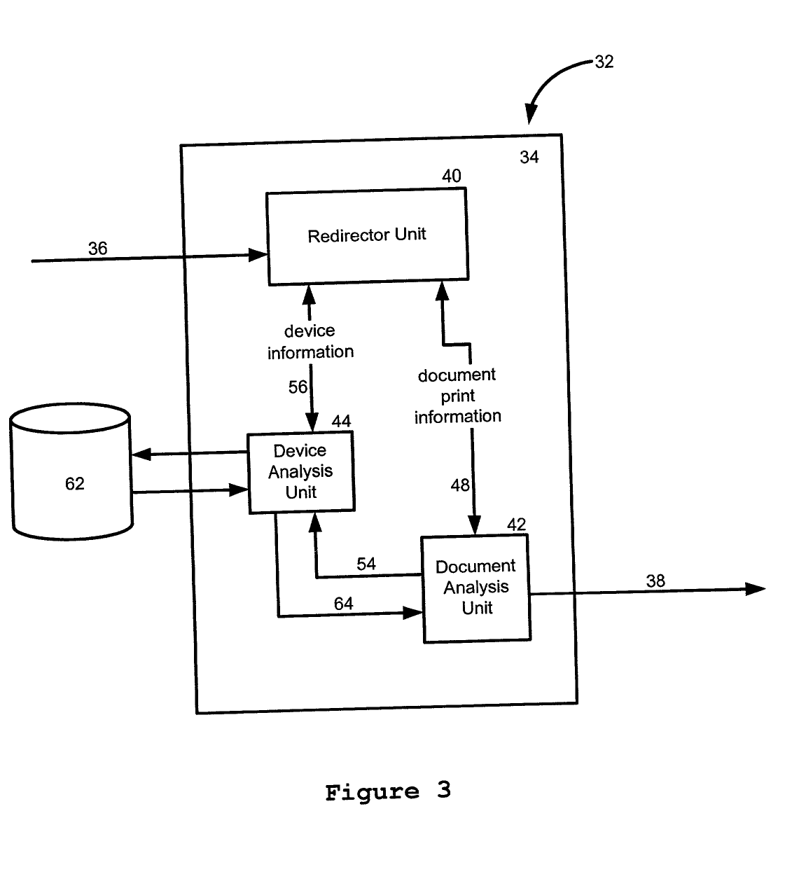

FIG. 3 illustrates a functional block diagram of the disbursement tracking system, in accordance with a non-limiting example of implementation of the invention. The disbursement tracking system identified by the reference numeral 32 includes a processing unit 34 having an input 36 and an output 38. Continuing with the above example, the input 36 receives input signals conveying document print information and device information, as described above, from the workstation 20. The output 38 releases an output signal to the printer/copier device 28, via the print server 24, the printer/copier device 28 being responsive to the output signal to effect the printing operation and generate the print data. The “output signal” encompasses messages received or sent that result in the printer/copier device 28 carrying out the printing operation.

The processing unit 34 includes a redirector unit 40 whose basic task is to intervene between the application that is generating the document print information and the various software and/or hardware components of the workstation 20 and/or the network that carry out the printing operation. More particularly, messages sent by the application generating the document print information and the operating system responsible for carrying out the printing operation are actually intercepted by the redirector unit 40 at input 36 and redirected within the processing unit 34. The redirector unit 40 acts in a transparent manner such that neither the application nor the various components that carry out the printing operation are aware of its presence.

Message and command redirector units are generally known in the art and it is not deemed necessary here to describe in detail the internal operation of this unit.

The processing unit 34 includes a document analysis unit 42 and a device analysis unit 44, both coupled to the redirector unit 40. The redirector unit 40 is operative to extract from the input signals arriving at input 36 the document print information and the device information, redirecting the document print information to the document analysis unit 42 and the device information to the device analysis unit 44. In this non-limiting example of implementation, the device information includes an identifier of the printer/copier device on which the document print information is to be generated.

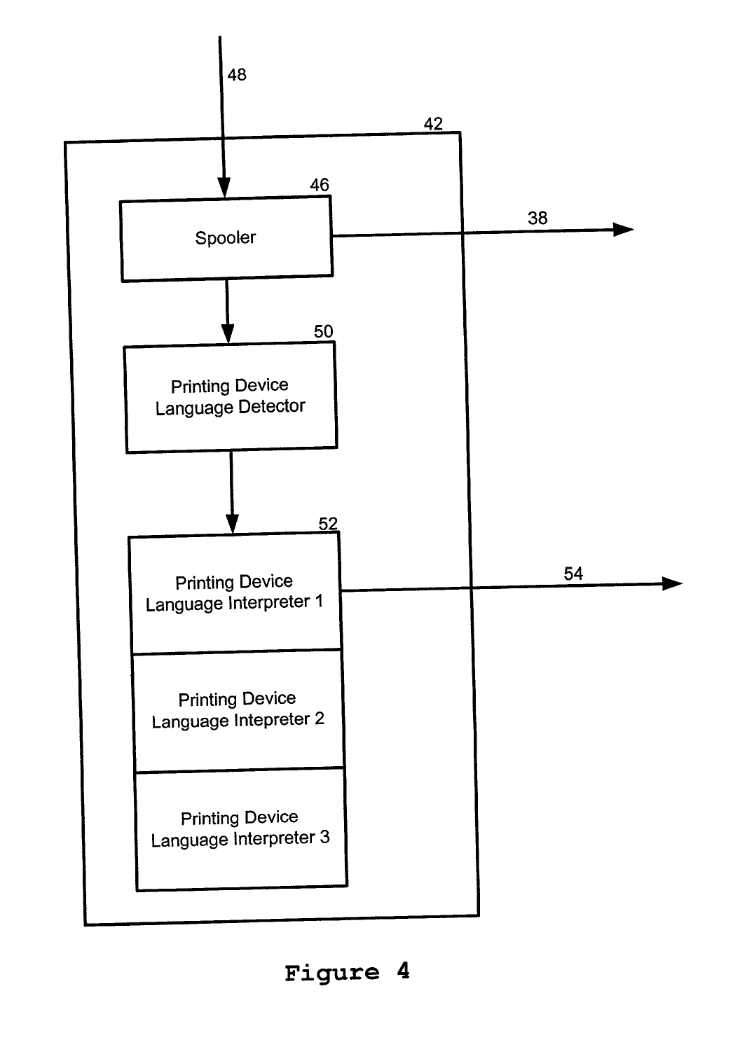

The purpose of the document analysis unit 42 is to spool the data contained in the document print information to create a print job file. A more detailed functional block diagram of the document analysis unit 42 is shown in FIG. 4. The document analysis unit 42 includes a spooler 46 that receives at its input 48 the document print information and is operative to accumulate into a print job file all of the document print information received from the application that attempts to print. The print job file is then passed to a printing device language detector 50 that attempts to determine in what language the document print information is communicated to the printer/copier device 28. Printer language detection is achieved by sampling up to the first 32K bytes of printer commands and looking for unique comments and/or control codes to identify the language. A typical case is the PCL (trademark) (Print Control Language) V language in which the command ESC-E will follow an optional section for comments. When the particular language is identified, the printing device language detector 50 will pass the print job file to a printing device language interpreter 52. In effect, the printing device language interpreter 52 is actually a collection of individual interpreters, each interpreter being associated to a different language. When the printing device language detector 50 identifies the language of the document print information, it activates the appropriate printing device language interpreter 52.

The document analysis unit 42 thus builds and maintains the print job file until one of two conditions is met. The first case occurs when a command to cancel the print job is detected by the printing device language interpreter 52, in which case the print job file is discarded. In the second case, where a command indicating that all document print information has been transmitted is read by the printing device language interpreter 52, the document analysis unit 42 generates and sends a signal to the device analysis unit 44 containing a request for cost allocation data, via output 54.

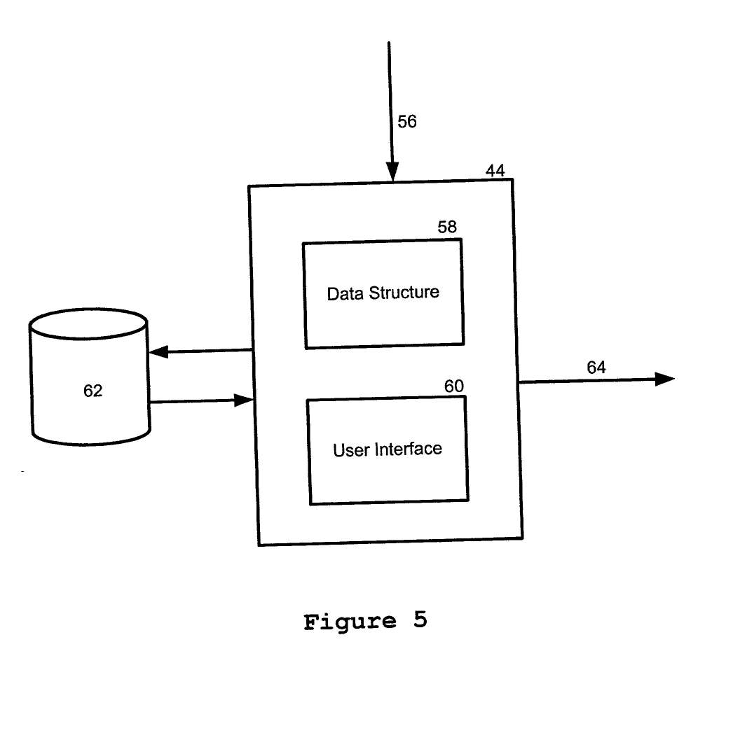

The purpose of the device analysis unit 44 is to determine the status of the printer/copier device 28 on which the document print information is to be generated, in particular the requirements of the printer/copier device 28 with respect to cost allocation data. As shown in FIG. 5, the device analysis unit 44 receives at input 56 the device information, including a device identifier, from the redirector unit 40. The device analysis unit 44 includes a computer readable storage medium holding a data structure 58 storing status information on a plurality of different output devices, in this example the printer/copier devices 26, 28 and 30. Upon receiving a device identifier representative of the printer/copier device 28 from the redirector unit 40, the device analysis unit 44 consults the data structure 58 on a basis of this device identifier in order to determine the status of the printer/copier device 28. The status information stored in the data structure 58 includes an indication as to whether or not the printer/copier device 28 requires cost allocation data.

If the device analysis unit 44 determines from the status information stored in the data structure 58 that the printer/copier device 28 does require device specific cost allocation data, the device analysis unit 44 is operative to collect and validate the cost allocation data from the operator at workstation 20. Accordingly, the device analysis unit 44 includes an interface unit 60 for retrieving from the user cost allocation data, such as the name or identifier of the client to whom the charge will be attributed, and/or details about the individual that has incurred the charge. In a specific, nonlimiting example, the cost allocation data is a combination of several data elements, namely:

5. User identification code;

6. User password

7. Name of client

8. Client matter

The operator enters the cost allocation data through the user interface. Under this specific example of implementation, the interface unit 60 creates a data capture dialog box or screen on the display of the workstation 20 where the user is required to key in the cost allocation data. Once the data entry process is completed, the device analysis unit 44 will attempt to validate the cost allocation data. During the validation process, the device analysis unit 44 will query a database 62 to determine if the information about the user identity, such as the user identification code and the user password, is valid or legitimate. In essence, these two elements are tested against a master list of user identification codes and corresponding passwords, that determines who is allowed to access and operate the system. Next the device analysis unit 44 will perform a similar verification against the client information entered by the user, to determine if it is valid client information.

If the device analysis unit 44 validates the cost allocation data entered by the user, the device analysis unit 44 will generate a first control signal, including the validated cost allocation data, and will send this signal to the document analysis unit 42 via output 64. If the cost allocation data entered by the user is invalid, the device analysis unit 44 will generate a second control signal directive to discard the print job file and will send this signal to the document analysis unit 42, via output 64.

If the device analysis unit 44 determines from the status information stored in the data structure 58 that the printer/copier 28 does not require cost allocation data, the device analysis unit 44 will generate a third control signal indicating that no cost allocation data is required and will send this signal to the document analysis unit 42 via output 64.

If the device analysis unit 44 determines from the status information stored in the data structure 58 that the printer/copier 28 requires cost allocation data but this cost allocation data is not immediately available or validation is not yet complete, the device analysis unit 44 will generate a fourth control signal indicating that cost allocation data is required but not yet available and will send this signal to the document analysis unit 42 via output 64.

The document analysis unit 42 is responsive to the signals received from the device analysis unit 44 to complete the printing operation. If the first control signal is received from the device analysis unit 44, including validated cost allocation data, the document analysis unit 42 will modify the print job file by inserting the cost allocation data into the print job file according to a predetermined format, as will be described in further detail below. The modified print job file is then released to the printer/copier device 28, via output 38. If the second control signal is received from the device analysis unit 44, the print job file is discarded by the document analysis unit 42. If the third control signal is received from the device analysis unit 44, the print job file is released unmodified from the document analysis unit 42 to the printer/copier device 28, via output 38. If the fourth signal is received from the device analysis unit 44, indicating that cost allocation data is required but not yet available, the document analysis unit 42 will wait for receipt of the first control signal from the device analysis unit 44, indicating that the cost allocation data has been validated. When the first control signal is received, the document analysis unit 42 follows the procedure for inserting the cost allocation data into the print job file and releasing the print job file to the printer/copier device 28, via output 38.

As mentioned above, the document analysis unit 42 performs the insertion of validated cost allocation data into the print job file according to a predetermined format. This predetermined format is dependent on the type of printer/copier device to which the print job file is being sent, and is such that both the print data and the printer commands forming the print job file remain unaffected. In particular, the predetermined format defines appropriate file positions at which the validated cost allocation data is to be inserted into the print job file, such that when the newly constructed print job file is supplied to the printer/copier device, the document generated by the printer/copier device is in its original form. In a specific example, The Document Company Xerox manufactures printer/copier devices that may be integrated for use with a disbursement tracking system such as the system defined by the present invention. To this end, Xerox has established industry wide device standards that define the expected location of cost allocation data within print job files received at a Xerox printer/copier device for outputting. Since the function of inserting control data, such as cost allocation data, into a print job file according to a device-specific predetermined format is well known to those skilled in the art, it will not be described in further detail.

The following detailed example illustrates the events that take place when a print job is initiated by a user from a typical 32-bit Windows95 application that uses the built in GDI print methods provided by the Windows95 API, with the disbursement tracking system resident. The presented scenario walks through the sequence of calls between the application, the Windows95 operating system and the disbursement tracking system components.

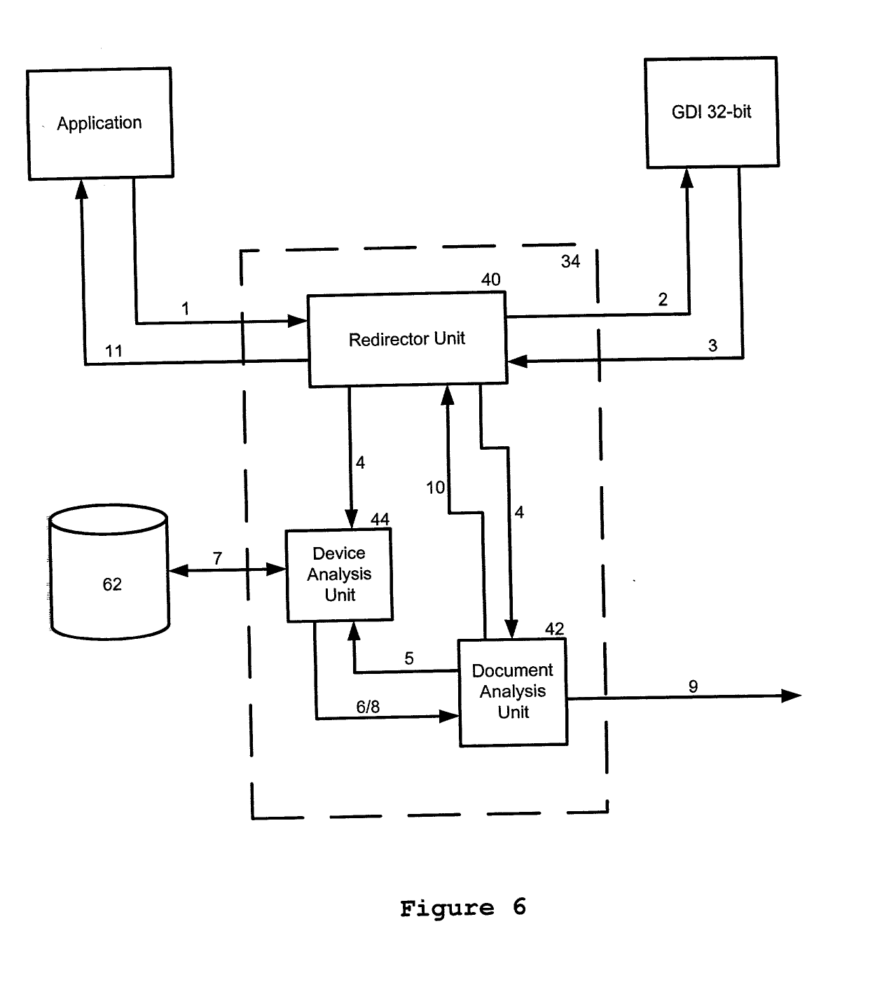

FIG. 6 shows the sequence of calls and events that start with the application initiating a print job. This step is labeled 1 in FIG. 6 and the final step, when the disbursement tracking system has finished processing the request, is labeled step 11. Note that between steps 2 and 3 there are many other Windos95 print components that come into play and have not been described in the interest of clarity.

1. The application has a graphics object, for example a circle, to send to a printer/copier device. The application creates a Device Context (DC) and calls the BDI StartDoc function to initiate a print request for the printer. This request may also contain a file name if the application wants to print directly to a file.

2. The redirector unit 40 intercepts the GDI calls from the application and creates memory objects containing information about the calls, including in particular the document print information. It then makes the call to the GDI as the source so that the GDI will return the results of the call back to it.

3. Depending on the type of printing (Direct, RAW spooling or EMF spooling), the GDI will have passed on commands to the appropriate printer components of the Windows95 operating system and return a result set back to the redirector unit 40, this result set forming at least in part the device information.

4. The redirector unit 40 redirects the document print information to the document analysis unit 42 and the device information to the device analysis unit 44.

5. The document analysis unit 42 is responsible for building and maintaining a print job file until either a command to cancel the print job is detected, in which case the print job file is discarded, or a command indicating that all document print information has been transmitted is detected. In the latter case, the document analysis unit 42 generates and sends a signal to the device analysis unit 44 containing a request for cost allocation data.

6. The device analysis unit 44 is responsible for determining the requirements of the printer/copier device on which the document print information is to be generated with respect to cost allocation data, on a basis of the device information received from the redirector unit 40. The device analysis unit 44 consults the data structure 58 on a basis of the device information in order to determine whether or not the printer/copier device requires cost allocation data. The device analysis unit 44 generates and sends a control signal to the document analysis unit 42, on a basis of which the document analysis unit 42 completes the printing operation.

7. If the device analysis unit 44 determines that the printer/copier device does require device specific cost allocation data, the device analysis unit sends a request to the user interface 60 to capture from the user the cost allocation data that is to be associated with the print job. The user interface 60 is responsible for retrieving cost allocation data such as the user's identification number, client and matter numbers or codes, job descriptions and billing codes. The device analysis unit 44 attempts to validate the retrieved cost allocation data.

8. If validation is successful, the device analysis unit 44 includes the validated cost allocation data with the control signal sent to the document analysis unit 42.

9. Upon receipt of the control signal, including the validated cost allocation data, from the device analysis unit 44, the document analysis unit 42 modifies the print job file by inserting the validated cost allocation data into the print job file according to a predefined format, and releases the modified print job file to the printer/copier device for printing.

10. The document analysis unit 42 reports back to the redirector unit 40 that the disbursement tracking system has now fully processed the GDI call.

11. The redirector unit 40 returns the GDI result set back to the originating 3^{rd} party application as if the call was processed directly by Windows95 itself.

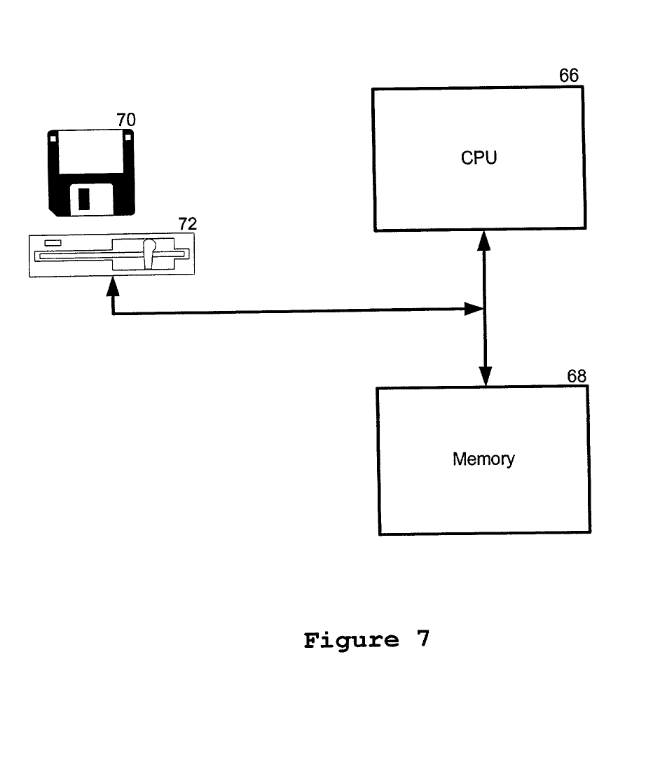

As previously mentioned, the disbursement tracking system according to this invention is software implemented on a computing platform, such as the workstation 20 and alternatively the print server 24. The basic structure of the computing device constituting the workstation 20 is depicted in FIG. 7. The computing device has a Central Processing Unit (CPU) 66, a memory 68 and a bus connecting the CPU 66 to the memory 68. The memory 68 holds program instructions for execution by the CPU 66 to implement the functionality of the disbursement tracking system. The disbursement tracking system may be stored on a computer readable medium 70, such as a floppy disk, that is external to the computing device. The floppy disk 70 can be read by a floppy drive 72 to load the program instructions in the memory 68. The computer readable medium 70 may be part of a remote computing platform that is in some way connected to the computing platform that executes the program element for allowing the data transfer necessary to pass the program element to the computing platform on which the execution will take place. For example, a file server containing the program element that can be accessed over any suitable connection by another computing platform to obtain the program element is considered a computer readable medium storing the program element.

Although various embodiments have been illustrated, this was for the purpose of describing, but not limiting, the invention. Various modifications will become apparent to those skilled in the art and are within the scope of this invention, which is defined more particularly by the attached claims.

I claim:

1. A disbursement tracking system, comprising:
a) an input for receiving input signals conveying data associated with a document a user desires to generate on an output device;
b) a processing unit coupled to said input, said processing unit operative to:
i) extract from said input signals document print information and device information;
ii) determine a status of the output device on a basis of the device information;
iii) generate an output signal on a basis of the document print information and the status of the output device;
c) an output coupled to said processing unit for releasing said output signal to the output device.

2. A disbursement tracking system as defined in claim 1, wherein, if the status of the output device requires cost allocation data, said processing unit is operative to:
a) retrieve from the user the cost allocation data;
b) attempt to validate the cost allocation data;
c) if the cost allocation data is validated, insert the validated cost allocation data into the output signal.

3. A disbursement tracking system as defined in claim 2, wherein said output signal is a print job file, said processing unit including a document analysis unit operative to spool the document print information extracted from said input signals into said print job file.

4. A disbursement tracking system as defined in claim 3, wherein said processing unit includes a device analysis unit operative to determine the status of the output device on a basis of the device information extracted from said input signals.

5. A disbursement tracking system as defined in claim 4, wherein said device information includes an identifier of the output device on which the document is to be generated.

6. A disbursement tracking system as defined in claim 5, wherein said device analysis unit includes a machine readable storage medium holding a data structure storing status information, said device analysis unit operative to consult said data structure on a basis of said identifier to determine the status information for the output device.

7. A disbursement tracking system as defined in claim 6, wherein said device analysis unit includes a user interface permitting the user to enter the cost allocation data.

8. A disbursement tracking system as defined in claim 7, wherein if the status information for the output device indicates that the output device requires cost allocation data, said device analysis unit is operative to initiate the user interface for collecting the cost allocation data from the user, said device analysis unit operative to attempt to validate the collected cost allocation data.

9. A disbursement tracking system as defined in claim 8, wherein if the collected cost allocation data is validated, said device analysis unit is operative to generate a first control signal including the cost allocation data.

10. A disbursement tracking system as defined in claim 8, wherein if the collected cost allocation data is invalid, said device analysis unit is operative to generate a second control signal, said document analysis unit responsive to said second control signal to discard said print job file.

11. A disbursement tracking system as defined in claim 9, wherein said document analysis unit is responsive to said first control signal for:
a) extracting from said first control signal the cost allocation data;
b) modifying said print job file generated on a basis of the document print information by inserting the cost allocation data according to a predetermined format into said print job file, said print job file including the cost allocation data being released from said output to the output device.

12. A disbursement tracking system as defined in claim 6, wherein if the status information for the output device indicates that the output device does not require cost allocation data, said device analysis unit is operative to generate a third control signal, said document analysis unit responsive to said third control signal for releasing said print job file generated on a basis of the document print information from said output without modification.

13. A disbursement tracking system as defined in claim 2, wherein the cost allocation data includes a user identification number and a file number.

14. A disbursement tracking system as defined in claim 1, wherein the output device is a digital printer/copier device.

15. A computer readable storage medium containing a program element for execution by a computing apparatus to implement a disbursement tracking system, said disbursement tracking system including:
a) an input for receiving input signals conveying data associated with a document a user desires to generate on an output device;
b) a processing unit coupled to said input, said processing unit operative to:
i) extract from said input signals document print information and device information;
ii) determine a status of the output device on a basis of the device information;
iii) generate an output signal on a basis of the document print information and the status of the output device;
c) an output coupled to said processing unit for releasing said output signal to the output device.

16. A computer readable storage medium as defined in claim 15, wherein, if the status of the output device requires cost allocation data, said processing unit is operative to:
a) retrieve from the user the cost allocation data;
b) attempt to validate the cost allocation data;
c) if the cost allocation data is validated, insert the validated cost allocation data into the output signal;

17. A computer readable storage medium as defined in claim 16, wherein said output signal is a print job file, said processing unit including a document analysis unit operative to spool the document print information extracted from said input signals into said print job file.

18. A computer readable storage medium as defined in claim 17, wherein said processing unit includes a device analysis unit operative to determine the status of the output device on a basis of the device information extracted from said input signals.

19. A computer readable storage medium as defined in claim 18, wherein said device information includes an identifier of the output device on which the document is to be generated.

20. A computer readable storage medium as defined in claim 19, wherein said device analysis unit includes a machine readable storage medium holding a data structure storing status information, said device analysis unit operative to consult said data structure on a basis of said identifier to determine the status information for the output device.

21. A computer readable storage medium as defined in claim 20, wherein said device analysis unit includes a user interface permitting the user to enter the cost allocation data.

22. A computer readable storage medium as defined in claim 21, wherein if the status information for the output device indicates that the output device requires cost allocation data, said device analysis unit is operative to initiate the user interface for collecting the cost allocation data from the user, said device analysis unit operative to attempt to validate the collected cost allocation data.

23. A computer readable storage medium as defined in claim 22, wherein if the collected cost allocation data is validated, said device analysis unit is operative to generate a first control signal including the cost allocation data.

24. A computer readable storage medium as defined in claim 22, wherein if the collected cost allocation data is invalid, said device analysis unit is operative to generate a second control signal, said document analysis unit responsive to said second control signal to discard said print job file.

25. A computer readable storage medium as defined in claim 23, wherein said document analysis unit is responsive to said first control signal for:
a) extracting from said first control signal the cost allocation data;
b) modifying said print job file generated on a basis of the document print information by inserting the cost allocation data according to a predetermined format into said print job file, said print job file including the cost allocation data being released from said output to the output device.

26. A computer readable storage medium as defined in claim 20, wherein if the status information for the output device indicates that the output device does not require cost allocation data, said device analysis unit is operative to generate a third control signal, said document analysis unit responsive to said third control signal for releasing said print job file generated on a basis of the document print information from said output without modification.

27. A computer readable storage medium as defined in claim 16, wherein the cost allocation data includes a user identification number and a file number.

28. A computer readable storage medium as defined in claim 15, wherein the output device is a digital printer/copier device.

29. A data processing device, comprising:
a) an input for receiving input signals containing data associated with a document a user desires to generate on an output device;
b) a redirector unit coupled to said input, said redirector unit operative to extract from said input signals document print information and device information;
c) a document analysis unit coupled to said redirector unit, said document analysis unit operative to generate an output signal on a basis of the document print information;
d) a device analysis unit coupled to said redirector unit, said device analysis unit operative to determine a status of the output device on a basis of the device information, if the status of the output device requires cost allocation data said device analysis unit being operative to:
i) retrieve from the user the cost allocation data;
ii) attempt to validate the cost allocation data;
iii) if the cost allocation data is validated, generate a control signal including the cost allocation data, said document analysis unit being responsive to said control signal for inserting the validated cost allocation data into the output signal;
e) an output for releasing said output signal to the output device.

30. A data processing device as defined in claim 29, wherein said output signal is a print job file, said document analysis unit being operative to spool the document print information extracted from said input signals into said print job file.

31. A data processing device as defined in claim 30, wherein said device information includes an identifier of the output device on which the document is to be generated.

32. A data processing device as defined in claim 31, wherein said device analysis unit includes a machine readable storage medium holding a data structure storing status information, said device analysis unit operative to consult said data structure on a basis of said identifier to determine the status information for the output device.

33. A data processing device as defined in claim 32, wherein said device analysis unit includes a user interface permitting the user to enter the cost allocation data.

34. A data processing device as defined in claim 33, wherein if the status information for the output device indicates that the output device requires cost allocation data, said device analysis unit is operative to initiate the user interface for collecting the cost allocation data from the user, said device analysis unit operative to attempt to validate the collected cost allocation data.

35. A data processing device as defined in claim 34, wherein if the collected cost allocation data is validated, said device analysis unit is operative to generate a first control signal including the cost allocation data.

36. A data processing device as defined in claim 34, wherein if the collected cost allocation data is invalid, said device analysis unit is operative to generate a second control signal, said document analysis unit responsive to said second control signal to discard said print job file.

37. A data processing device as defined in claim 35, wherein said document analysis unit is responsive to said first control signal for:
a) extracting from said first control signal the cost allocation data;
b) modifying said print job file generated on a basis of the document print information by inserting the cost allocation data according to a predetermined format into said print job file, said print job file including the cost allocation data being released from said output to the output device.

38. A data processing device as defined in claim 33, wherein if the status information for the output device indicates that the output device does not require cost allocation data, said device analysis unit is operative to generate a third control signal, said document analysis unit responsive to said third control signal for releasing said print job file generated on a basis of the document print information from said output without modification.

39. A data processing device as defined in claim 29, wherein the cost allocation data includes a user identification number and a file number.

40. A data processing device as defined in claim 29, wherein the output device is a digital printer/copier device.

41. A method for validating and controlling the transmission of document print information from a document creation device to an output device on which costs are incurred, said method comprising:
a) receiving input signals from the document creating device conveying data associated with a document a user desires to generate on the output device;
b) extracting from the input signals document print information and device information;
c) generating an output signal on a basis of the document print information;
d) determining a status of the output device on a basis of the device information, if the status of the output device requires cost allocation data:
i) retrieving from the user the cost allocation data;
ii) attempting to validate the cost allocation data;
iii) if the cost allocation data is validated, modifying the output signal by inserting the validated cost allocation data into the output signal;
e) releasing the output signal to the output device.

42. A method as defined in claim 41, wherein if the status of the output device does not require cost allocation data, said method comprising the step of releasing the output signal generated on a basis of the document print information from the output without modification.

43. A method as defined in claim 42, wherein the output signal is a print job file, said method comprising spooling the document print information extracted from the input signals into said print job file.

44. A method as defined in claim 41, wherein the cost allocation data includes a user identification number and a file number.

45. A method as defined in claim 41, wherein the output device is a digital printer/copier device.

46. A disbursement tracking system, comprising:
a) input means for receiving input signals conveying data associated with a document a user desires to generate on an output device;
b) processing means coupled to said input means, said processing means operative to:
i) extract from said input signals document print information and device information;
ii) determine a status of the output device on a basis of the device information;
iii) generate an output signal on a basis of the document print information and the status of the output device;
c) output means coupled to said processing means for releasing said output signal to the output device.
